(19) United States
(12) Patent Application Publication
(10) Pub. No.: US 2015/0263788 A1
(43) Pub. Date: Sep. 17, 2015

(54) WIRELESS APPARATUS, WIRELESS DEVICE, AND COMMUNICATION METHOD

(71) Applicant: Icom Incorporated, Osaka (JP)

(72) Inventor: Futoshi OTA, Osaka (JP)

(73) Assignee: Icom Incorporated

(21) Appl. No.: 14/643,120

(22) Filed: Mar. 10, 2015

(30) Foreign Application Priority Data
Mar. 13, 2014 (JP) 2014-050060

(51) Int. Cl. H04B 5/00; H04M 1/60

(52) U.S. Cl. CPC H04B 5/0031; H04M 1/6066

(57) ABSTRACT

A wireless apparatus has a wireless device and a communication terminal. When an instruction associated with a first function of the wireless device is inputted, the communication terminal transmits the inputted instruction to the wireless device through near-field wireless communication. The wireless device performs data communication with the communication terminal. The wireless device, when the instruction is received through the near-field wireless communication, interprets the instruction as an instruction associated with a second function of the wireless device that differs from the first function, and accordingly controls the second function.

### BACKGROUND OF THE INVENTION

1. Field of the Invention

The invention relates to wireless apparatuses for data communication between communication terminals and wireless devices through near-field wireless communication, wireless devices for use in the wireless apparatuses, and communication methods wherein the wireless apparatuses are used for data communication.

2. Description of the Related Art

Some of the conventionally available wireless apparatuses are furnished with a PTT (push to talk) switch-equipped wireless device, and also a PTT switch-equipped headset designed to accommodate the users' needs. In such wireless apparatuses, it has been sought that the wireless device and the headset be operable to wirelessly communicate with each other for even better user-friendliness.

With an aim to achieve the goal, JP 2008-141744 A, for example, discloses a wireless apparatus, wherein a wireless device is combined with a wireless headset that complies with a near-field wireless communication protocol, for example, Bluetooth (registered trademark) protocol.

Mobile telephones are general-purpose devices used to communicate with other devices through voices and sounds in compliance with the near-field wireless communication protocol. In such mobile telephone are used standardized profiles for near-field wireless communication for incoming and outgoing communications, calls, and Voice input-output.

For switching control of the wireless apparatus to and from transmission and reception by manipulating the PTT switch of the wireless headset through the near-field wireless communication, as with the case of mobile telephones, the near-field wireless communication protocol needs to provide a profile associated with handling of the PTT switch.

Due to the lack of such a profile in the existing near-field wireless communication protocol, however, it becomes necessary to prepare a dedicated profile for the transmission-reception switching control of the wireless apparatus with handling of the PTT switch through the near-field wireless communication. The necessity of such a dedicated profile is an additional burden in designing the wiring apparatus. None of the commercially available headsets is operable to handle any dedicated profiles, which raises the demand for availability of dedicated wireless headsets operable to handle such a profile.

The invention provides a wireless apparatus wherein the transmission-reception switching control is enabled by manipulating the PTT switch in the near-field wireless communication without the dedicated profile, a wireless device for use in the wireless apparatus, and a communication method wherein the wireless apparatus is used for data communication.

### SUMMARY OF THE INVENTION

A wireless apparatus according to the invention includes:

a wireless device; and

a communication terminal,

the wireless device performing data communication with the communication terminal through near-field wireless communication and further wirelessly communicating data transmitted and received through the data communication with another wireless device, wherein

the communication terminal includes:
a function input unit for receiving an instruction associated with a first function of the wireless device inputted by an operator of the communication terminal; and
a terminal-side communication module for performing the data communication with the wireless device, the terminal-side communication module further transmitting the instruction inputted to the function input unit to the wireless device through the near-field wireless communication,
the wireless device includes:
a wireless device-side communication module for performing the data communication with the communication terminal, the wireless device-side communication module further receiving the instruction transmitted from the communication terminal through the near-field wireless communication; and
a function controller for controlling functions based on the instruction received by the wireless device-side communication module, and
the function controller of the wireless device interprets the instruction as an instruction associated with a second function of the wireless device that differs from the first function to further control the second function.

A wireless device according to the invention is a wireless device for performing data communication with a communication terminal through near-field wireless communication, the wireless device further wirelessly communicating data transmitted and received through the data communication with another wireless device,
the wireless device including:
a wireless device-side communication module; and
a function controller, wherein
the wireless device-side communication module performs the data communication with the communication terminal, the wireless device-side communication module further receiving an instruction associated with a first function of the wireless device transmitted from the communication terminal through the near-field wireless communication,
the function controller controls functions based on the instruction received by the wireless-device side communication module, and
the function controller interprets the instruction as an instruction associated with a second function of the wireless device that differs from the first function to further control the second function.

Preferably, the first function is a function defined in a universal profile of the near-field wireless communication, and the second function is a function not defined in the universal profile of the near-field wireless communication.

Preferably, the communication terminal is a wireless headset for performing voice communication with the wireless device through the near-field wireless communication, and the data is voice data.

Preferably, the function controller of the wireless device determines whether the communication terminal is a device compliant with a dedicated profile defining the second function at the time of starting to communicate with the communication terminal, and
the function controller interprets the instruction as the instruction associated with the second function that differs from the first function to further control the second function when the communication terminal is determined to be a device non-compliant with the dedicated profile.

A communication method according to the invention is a communication method employed for a wireless device to communicate with a communication terminal through near-field wireless communication, the wireless device performing data communication with the communication terminal through the near-field wireless communication and further wirelessly communicating data transmitted and received through the data communication with another wireless device, wherein

the communication method includes:
a first step of receiving by the communication terminal an instruction associated with a first function of the wireless device inputted by an operator of the communication terminal;
a second step of performing the data communication between the communication terminal and the wireless device, the second step further transmitting the instruction inputted in the first step from the communication terminal to the wireless device through the near-field wireless communication.
a third step of controlling functions by the wireless device that received the instruction transmitted from the communication terminal, and
in the third step, the wireless device interprets the instruction as an instruction associated with a second function of the wireless device that differs from the first function to further control the second function.

Preferably, the first function is a function defined in a universal profile of the near-field wireless communication, and the second function is a function not defined in the universal profile of the near-field wireless communication.

Preferably, the communication terminal is a wireless headset for performing voice communication with the wireless device through the near-field wireless communication, and the data is voice data.

Preferably, in the third step, the wireless device determines whether the communication terminal is a device compliant with a dedicated profile defining the second function at the time of starting to communicate with the communication terminal, and
the function controller interprets the instruction as the instruction associated with the second function that differs from the first function to further control the second function when the communication terminal is determined to be a device non-compliant with the dedicated profile.

According to the invention, the data communication between the communication terminal and the wireless device is performed by interpreting the instruction associated with the second function not defined in the profile of the near-field wireless communication as the instruction associated with the first function defined in the profile of the near-field wireless communication, and after the data communication between them (data reception) is over, the wireless device interprets the instruction associated with the first function as the instruction associated with the second function and controls the second function therein.

Thereby according to the invention, though the control of the second function such as PTT function is not defined in the universal profile of the near-field wireless communication, any devices not operable to handle such a dedicated profile can advantageously carry out the second function.

### BRIEF DESCRIPTION OF THE DRAWINGS

These and other objects as well as advantages of the invention will become clear by the following description of an embodiment and appended claims of the invention. A number of benefits undisclosed in this description will come to the attention of those skilled in the art when they actualize the present invention.

FIG. 1 is a block diagram illustrating a wireless apparatus according to an embodiment of the invention.

FIG. 2 is a drawing to offer for explanation of data transmission and reception by the wireless apparatus of FIG. 1.

### DETAILED DESCRIPTION OF THE INVENTION

Prior to the description of an embodiment of the invention, hands-free function and PTT (push-to-talk) function are described. The hands-free function is defined in a universal profile of near-field wireless communication, and this function represents a first function according to the invention. The profile defining the hands-free function is a hands-free profile. The universal hands-free profile is hereinafter abbreviated to HFP. The HFP is a universal profile as described above. The PTT function is not defined in the universal profile of the near-field wireless communication, and this function represents a second function according to the invention.

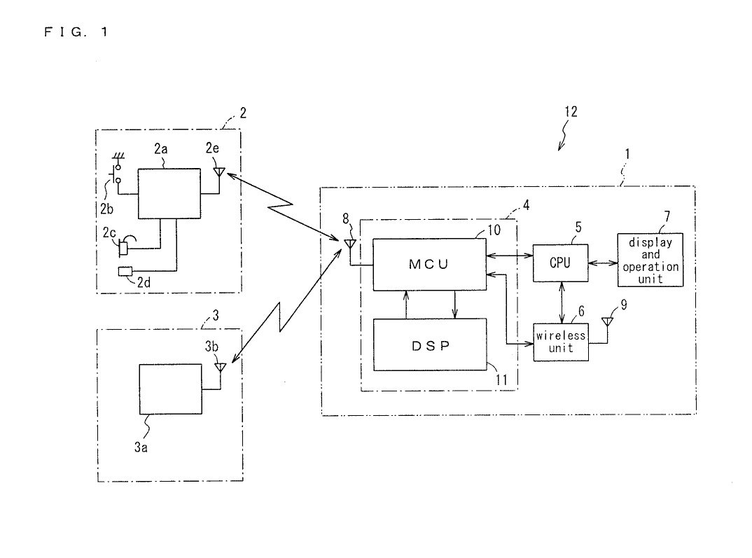

The invention is hereinafter described in detail. Referring to FIG. 1, a wireless apparatus 12 has a wireless device 1, a wireless headset 2 which is an example of communication terminals, and a data terminal 3.

The wireless device 1 has a wireless unit 6, a communication module 4, a CPU 5 that controls the whole operation of the wireless device, a display and operation unit 7, a near-field wireless antenna 8, and a wireless antenna 9.

The wireless unit 6 wirelessly communicates with another wireless device not illustrated in the drawing. The communication module 4 performs near-field wireless communication, such as Bluetooth communication, with the wireless headset 2 and the data terminal 3. The display and operation unit 7 displays thereon indications relating to the operation of the wireless device 1 and accepts operational instructions inputted by an operator who operates the wireless device 1. The near-field wireless antenna 8 transmits and receives data to and from the wireless headset 2 and the data terminal 3 through the near-field wireless communication. The wireless antenna 9 wirelessly transmits and receives data to and from another wireless device not illustrated in the drawing.

The communication module 4 processes voice data. For transmission-reception switching control of the wireless apparatus 12 using a PTT switch, the communication module 4 further carries out processes compliant with a dedicated profile defining the PTT function, and processes compliant with a universal profile (for example, HFP) not defining the PTT function.

To carry out these processes, the communication module 4 has a MCU (microcontroller unit) 10, a DSP (digital signal processor) 11. The MCU 10, DSP 11, and CPU 5 constitute a function controller of the wireless device 1.

The wireless headset 2 is a communication terminal used for data communication with the wireless device 1 through the near-field wireless communication. The wireless headset 2 is, for example, worn on an operator's head to transmit and receive voice data to and from the wireless device 1 through near-field wireless communication. To this end, the wireless headset 2 has a communication module 2a, a PTT switch 2b, a headphone 2c, a microphone 2d, and a near-field wireless antenna 2e.

The PTT switch 2b is a function input unit of the wireless headset 2. The headphone 2c may be an earphone. The communication module 2a carries out processes compliant with the universal profile HFP. The drawing illustrates a monaural headphone as an example of the headphone 2c.

The data terminal 3 transmits and receives data to and from the wireless device 1 through the near-field wireless communication. To this end, the data terminal 3 has a communication module 3a and a near-field wireless antenna 3b. The communication module 3a carries out processes compliant with the universal profile.

The wireless apparatus 12 runs the PTT function using the universal profile HFP (hands-free profile) of the near-field wireless communication that defines the hands-free function (first function). The HFP is a profile that enables hands-free calls in vehicles or with a headset.

The HFP includes a command issued to execute a hands-free call related function, and a command issued to execute an incoming-outgoing communication function.

The HFP allows the wireless device 1 to operate as HFP-defined Voice Gateway (hereinafter, AG), and the wireless headset 2 to operate as a HFP-defined hands-free unit (hereinafter, HF). The AG is a function for sending and receiving voice communication during the HFP processes. The HF is a hands-free function for carrying out, for example, outgoing request of voice calls, answering for incoming calls, and hands-free calls between the AG during the HFP processes.

In the wireless apparatus 12, in order to fulfill the PTT function, commands to be transmitted from the wireless headset 2 to the wireless device 1 are; a command broadcasting that the PTT switch 2b is pressed down (PTT on), and a command broadcasting that the pressed-down PTT switch 2b is released (PTT off).

These commands exist in the PTT-dedicated profile defining the PTT function, but not in the HFP not defining the PTT function. To fulfill the PTT function, therefore, a PTT-dedicated wireless headset compliant with the PTT-dedicated profile is conventionally necessary.

The wireless headset 2 complies with the universal HFP alone, but not with the dedicated profile targeted for the PTT function. According to this embodiment, the wireless headset 2 fulfills the PTT function by using HFP commands, (AT+BVRA), (AT+BLDN), and (AT+CHUP).

The communication module 2a of the wireless headset 2 uses an HFP command (AT+BVRA=1) or (AT+BLDN) as a replacement for the command (PTT on). The command (AT+BVRA=1) is a command transmitted when requesting to start voice recognition in the HFP. The command (AT+BLDN) is a command transmitted when requesting to redial the number of the last outgoing call in the HF.

At the time of transmitting the command (PTT on), the communication module 2a, as a replacement for this command, transmits the command (AT+BVRA=1) or (AT+BLDN) to the wireless device 1.

The communication module 2a uses an HFP command (AT+BVRA=0) or (AT+CHUP) as a replacement for the command (PTT off). The command (AT+BVRA=0) is a command transmitted when requesting to terminate voice recognition in the HFP. The command (AT+CHUP) is a command transmitted when requesting to terminate (disconnect) a voice call in the HFP.

At the time of transmitting the command (PTT off), the communication module 2a, as a replacement for this command, transmits the command (AT+BVRA=0) or (AT+CHUP) to the wireless device 1.

The communication module 4 of the wireless device 1, upon receipt of the command (AT+BVRA=1) or (AT+BLDN) from the wireless headset 2, interprets the received command as the command (PTT on).

The communication module 4, upon receipt of the command (AT+BVRA=0) or (AT+CHUP) from the wireless headset 2, interprets the received command as the command (PIT off. Thus, the communication module 4 that received the command (AT+BVRA=1) or (AT+CHUP) interprets the received command as the command (PTT on) broadcasting that the PTT switch 2b is pressed down.

Similarly, the communication module 4 that received the command (AT+BVRA=0) or (AT+CHUP) interprets the received command as the command (PTT off) broadcasting that the pressed-down PTT switch 2b is released.

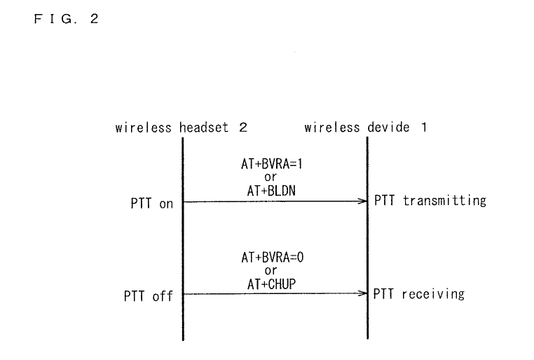

A communication method according to the invention is hereinafter described referring to FIG. 2. To start with, the wireless device 1 and the wireless headset 2 are connected to each other as set forth in the near-field wireless communication protocol. When the wireless device 1 and the wireless headset 2 are connected, these devices respectively register therein the other device connected thereto. The registration is done by exchanging pass keys (PIN codes) between the wireless device 1 and the wireless headset 2, which is termed as paring in the near-field wireless communication protocol.

When the paring succeeds, a link key is created. The link key is stored in the communication module 4 of the wireless device 1 and the communication module 2a of the wireless headset 2. Conventionally, the wireless device 1 and the wireless headset 2 are spaced apart to an extent that allows mutual communication therebetween, and these devices are accordingly switched to “paring mode”. Then, paring of these devices is completed.

The wireless device 1 and the communication module 2a switched to the paring mode are automatically set as paired devices, and wirelessly connection between these devices by the near-field wireless communication starts.

For paring, PIN codes (may be called pass keys or PIN keys) are inputted, and a link key specific to the paired devices is created based on the inputted codes. The link key thus created allows data communication between the paired devices. The wireless device 1 and the wireless headset 2 located within a mutually communicable range can recognize each other as pared partners.

Since the link key is stored in the wireless device 1 and the wireless headset 2 once these devices are paired, paring is essentially no longer necessary with these devices that already succeeded in paring.

At the time of paring, the wireless device 1 recognizes whether the wireless headset 2 paired therewith is a PTT-dedicated headset compliant with the dedicated profile defining the PTT function, or a HFP-compliant headset which is compliant with the universal profile not defining the PTT function. The recognition is made by the communication module 4 or the CPU 5 of the wireless device 1. More specifically, for example, in the communication module 4 of the wireless device 1 is stored beforehand information of products compliant with the dedicated profile enabling the PTT function (for example, product names, identification codes, manufacturer identification codes). In the wireless device 1, product information of the wireless headset 2 is obtained at the time of paring, and then compared to the information previously stored in the communication module 4 to discriminate the type of the wireless headset 2.

Based on the recognition, the wireless device 1 deems the wireless headset 2 currently paired therewith to be a wireless headset in which the PTT function is replaced with the HFP function. The wireless device 1 thereafter interprets the HFP commands received from the wireless headset 2 as commands containing instructions to control the PTT function.

Referring to FIG. 2, when performing voice communication using the wireless apparatus 12 with another wireless device not illustrated in the drawing after the paring of the wireless device 1 and the wireless headset 2 is completed, an operator presses down the PTT switch 2b of the wireless headset 2.

When the PTT switch 2b is pressed down, the communication module 2a of the wireless headset 2 issues the command (AT+BVRA=1) or (AT+BLDN), and transmits the issued command to the wireless device 1 through the near-field wireless antenna 2e. Whether the command (AT+BVRA=1) or (AT+BLDN) is issued relies upon the technical spec of the wireless headset 2.

In the wireless device 1, the command received through the near-field wireless antenna 8 is interpreted by the MCU 10 or the DSP 11 of the communication module 4. The MCU 10 or the DSP 11 that recognized that the received command is the command (AT+BVRA=1) or (AT+BLDN) notifies the CPU 5 of the receipt of the command. The CPU 5 notified of the command receipt interprets that the PTT switch 2b has been pressed down and sends a transmit instruction to the wireless unit 6.

The wireless unit 6, based on the transmit instruction from the CPU 5, sets a transmit frequency. The voice data is transmitted from the wireless headset 2 through the near-field wireless antenna 2e. The transmitted voice data is received by the near-field wireless antenna 8 of the wireless device 1. The voice data received by the wireless device 1 is voice-processed, if necessary, by the MCU 10 of the communication module 4, and then inputted to the wireless unit 6 as analogue voice data.

The wireless unit 6 modulates the inputted analogue voice data and transmits the modulated voice data at the set transmit frequency through the wireless antenna 9. When finishing the transmission of the modulated voice data, the operator releases the pressed-down PTT switch 2b of the wireless headset 2. When the pressed-down PTT switch 2b is released, the communication module 2a issues the command (AT+BVRA=0) or (AT+CHUP) and transmits the issued command to the wireless device 1 through the near-field wireless antenna 2a. Which of the commands is issued relies upon the technical spec of the wireless headset 2.

In the wireless device 1, when the command is received through the near-field wireless antenna 8, the received command is interpreted by the MCU 10 or the DSP 11 of the communication module 4. The MCU 10 or the DSP 11 that recognized that the received command is the command (AT+BVRA=0) or (AT+CHUP) notifies the CPU 5 of the receipt of the command. The CPU 5 notified of the command receipt interprets that the pressed-down PTT switch 2b has been released and sends an instruction to terminate instruction to the wireless unit 6. Based on the instruction from the CPU 5, the wireless unit 6 terminates data transmission and sets a receive frequency. Then, the wireless unit 6 is ready for next data communication.

To ensure the successful receipt of the instruction from the wireless headset 2 compliant with the universal HFP, the wireless device 1, as to the PTT function-enabling command (PTT on) and command (PTT off), recognizes PTT on or PTT off based on the two HFP commands.

The wireless headset 2 compliant with the universal HFP supports one of or both of the HFP commands, [(AT+BVRA 1), (AT+BVRA=0) and [(AT+BLDN)], (AT+CHUP)]. The wireless device 1, through interpretation of the two commands as indicating the condition of the PTT switch 2b; pressed or not pressed, is able to recognize whether PTT on or PTT off based on the command transmitted from the wireless headset 2 paired with the wireless device 1, regardless of what type of universal HFP-compliant wireless headset 2 is paired therewith.

This embodiment exemplifies the wireless headset 2 as a device connected to the wireless device 1 through the near-field wireless communication. The device connected to the wireless device 1 through the near-field wireless communication is not necessarily such a wireless headset. The wireless device 1 can fulfill the second function with any device that can be connected to the wireless device 1 through the near-field wireless communication, for example, the data terminal 3.

The most preferred embodiment of the invention was thus far described in detail. This embodiment, however, may be variously modified without departing from the spirit and the scope of the invention defined in the appended claims.

What is claimed is:

1. A wireless apparatus comprising:
a wireless device; and
a communication terminal,
the wireless device performing data communication with the communication terminal through near-field wireless communication and further wirelessly communicating data transmitted and received through the data communication with another wireless device, wherein
the communication terminal comprises:
a function input unit for receiving an instruction associated with a first function of the wireless device inputted by an operator of the communication terminal; and
a terminal-side communication module for performing the data communication with the wireless device, the terminal-side communication module further transmitting the instruction inputted to the function input unit to the wireless device through the near-field wireless communication,
the wireless device comprises:
a wireless device-side communication module for performing the data communication with the communication terminal, the wireless device-side communication module further receiving the instruction transmitted from the communication terminal through the near-field wireless communication; and
a function controller for controlling functions based on the instruction received by the wireless device-side communication module, and
the function controller of the wireless device interprets the instruction as an instruction associated with a second function of the wireless device that differs from the first function to further control the second function.

2. The wireless apparatus as claimed in claim 1, wherein
the first function is a function defined in a universal profile of the near-field wireless communication, and
the second function is a function not defined in the universal profile of the near-field wireless communication.

3. The wireless apparatus as claimed in claim 1, wherein
the communication terminal is a wireless headset for performing voice communication with the wireless device through the near-field wireless communication, and the data is voice data.

4. The wireless apparatus as claimed in claim 1, wherein
the function controller of the wireless device determines whether the communication terminal is a device compliant with a dedicated profile defining the second function at the time of starting to communicate with the communication terminal, and
the function controller interprets the instruction as the instruction associated with the second function that differs from the first function to further control the second function when the communication terminal is determined to be a device non-compliant with the dedicated profile.

5. A wireless device for performing data communication with a communication terminal through near-field wireless communication, the wireless device further wirelessly communicating data transmitted and received through the data communication with another wireless device, the wireless device comprising:
a wireless device-side communication module; and
a function controller, wherein
the wireless device-side communication module performs the data communication with the communication terminal, the wireless device-side communication module further receiving an instruction associated with a first function of the wireless device transmitted from the communication terminal through the near-field wireless communication,
the function controller controls functions based on the instruction received by the wireless-device side communication module, and
the function controller interprets the instruction as an instruction associated with a second function of the wireless device that differs from the first function to further control the second function.

6. The wireless device as claimed in claim 5, wherein
the first function is a function defined in a universal profile of the near-field wireless communication, and
the second function is a function not defined in the universal profile of the near-field wireless communication.

7. The wireless device as claimed in claim 5, wherein
the communication terminal is a wireless headset for performing voice communication with the wireless device through the near-field wireless communication, and
the data is voice data.

8. The wireless device as claimed in claim 5, wherein
the function controller of the wireless device determines whether the communication terminal is a device compliant with a dedicated profile defining the second function at the time of starting to communicate with the communication terminal, and
the function controller interprets the instruction as the instruction associated with the second function that differs from the first function to further control the second function when the communication terminal is determined to be a device non-compliant with the dedicated profile.

9. A communication method employed for a wireless device to communicate with a communication terminal through near-field wireless communication, the wireless device performing data communication with the communication terminal through the near-field wireless communication and further wirelessly communicating data transmitted and received through the data communication with another wireless device, wherein
the communication method comprises:
a first step of receiving by the communication terminal an instruction associated with a first function of the wireless device inputted by an operator of the communication terminal;
a second step of performing the data communication between the communication terminal and the wireless device, the second step further transmitting the instruction inputted in the first step from the communication terminal to the wireless device through the near-field wireless communication,
a third step of controlling functions by the wireless device that received the instruction transmitted from the communication terminal, and
in the third step, the wireless device interprets the instruction as an instruction associated with a second function of the wireless device that differs from the first function to further control the second function.

10. The communication method as claimed in claim 9, wherein
the first function is a function defined in a universal profile of the near-field wireless communication, and
the second function is a function not defined in the universal profile of the near-field wireless communication.

11. The communication method as claimed in claim 9, wherein
the communication terminal is a wireless headset for performing voice communication with the wireless device through the near-field wireless communication, and
the data is voice data.

12. The communication method as claimed in claim 9, wherein
in the third step, the wireless device determines whether the communication terminal is a device compliant with a dedicated profile defining the second function at the time of starting to communicate with the communication terminal, and
the function controller interprets the instruction as the instruction associated with the second function that differs from the first function to further control the second function when the communication terminal is determined to be a device non-compliant with the dedicated profile.
